(19) United States
(12) Patent Application Publication
(10) Pub. No.: US 2025/0301378 A1
(43) Pub. Date: Sep. 25, 2025

(54) Figuring Out at a Second Network Node Whether a SHR Report (Received at a First Network Node from a UE) and a RLF Report (Received Thereafter at Said First Network Node) are in Fact Associated with the Same Handover

(71) Applicant: Telefonaktiebolaget LM Ericsson (publ), Stockholm (SE)

(72) Inventors: Marco Belleschi, Solna (SE); Ali Parichehrehteroujeni, Linköping (SE); Julien Muller, Rennes (FR)

(21) Appl. No.: 18/863,505

(22) PCT Filed: May 5, 2023
(86) PCT No.: PCT/SE2023/050443

§ 371 Date: Nov. 6, 2024

Related U.S. Application Data
(60) Provisional application No. 63/364,352, filed on May 9, 2022.

(51) Int. Cl. H04W 36/00

(52) U.S. Cl. CPC H04W 36/0079

(57) ABSTRACT

Embodiments herein may relate to a method performed by a first network node (12) for handling communication in a wireless communications network. The first network node (12) obtains a first report and/or a second report relating to radio performance and/or handover, HO, of a user equipment, UE, (10); and transmits to a second network node (13), one or more indication messages, wherein an indication message is associated with the first report and the second report.

### TECHNICAL FIELD

Embodiments herein relate to a first network node and a second network node, and methods performed therein regarding communication in a wireless communication network. Furthermore, a computer program product and a computer-readable storage medium are also provided herein. Especially, embodiments herein relate to handling or enabling communication, e.g., handling reports related to handovers (HO), in the wireless communication network.

### BACKGROUND

In a typical wireless communication network, user equipments (UE), also known as wireless communication devices, mobile stations, stations (STA) and/or wireless devices, communicate via a Radio access Network (RAN) to one or more core networks (CN). The RAN covers a geographical area which is divided into service areas or cells, with each service area or cell being served by a radio network node such as an access node, e.g., a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the UEs within range of the access node. The radio network node communicates over a downlink (DL) to the UE and the UE communicates over an uplink (UL) to the radio network node. The radio network node may be a distributed node comprising a remote radio unit and a separated baseband unit.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with UEs. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases, such as 5G networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies also known as new radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

5G is the fifth generation of cellular technology and was introduced in Release 15 of the 3GPP standard. It is designed to increase speed, reduce latency, and improve flexibility of wireless services. The 5G system (5GS) includes both a new radio access network (NG-RAN) and a new core network (5GC).

A Self-Organizing Network (SON) is an automation technology designed to make the planning, configuration, management, optimization and healing of mobile radio access networks simpler and faster. SON functionality and behavior has been defined and specified in generally accepted mobile industry recommendations produced by organizations such as 3^{rd} Generation Partnership Project (3GPP) and the Next Generation Mobile Networks (NGMN).

In 3GPP, the processes within the SON area are classified into Self-configuration process and Self-optimization process. Self-configuration process is the process where newly deployed nodes are configured by automatic installation procedures to get the necessary basic configuration for system operation.

This process works in a pre-operational state. The pre-operational state is understood as the state from when the eNB is powered up and has backbone connectivity until the radio frequency (RF) transmitter is switched on.

As illustrated in FIG. 1, functions handled in the pre-operational state such as:
Basic Setup; and
Initial Radio Configuration,
are covered by the Self Configuration process.

The self-optimization process is defined as the process where UE and access node measurements and performance measurements are used to auto-tune the wireless communication network.

This process works in an operational state. The operational state is understood as the state where the RF interface is additionally switched on.

As described in FIG. 1, functions handled in the operational state such as:
Optimization and/or Adaptation
are covered by the Self Optimization process.

FIG. 1 shows ramifications of Self-Configuration/Self-Optimization functionality, from 3GPP TS 36.300 v. 17.0.0 FIG. 22.1-1.

In LTE, support for Self-Configuration and Self-Optimisation is specified, as described in 3GPP TS 36.300 v. 17.0.0 section 22.2, including features such as Dynamic configuration, Automatic Neighbour Relation (ANR), Mobility load balancing, Mobility Robustness Optimization (MRO), random access channel (RACH) optimization and support for energy saving.

In NR, support for Self-Configuration and Self-Optimisation is specified as well, starting with Self-Configuration features such as Dynamic configuration and ANR in Release (Rel)-15, as described in 3GPP TS 38.300 v. 17.0.0 section 15. In NR Rel-16, more SON features are being specified for, including Self-Optimisation features such as Mobility Robustness Optimization (MRO).

### MRO in 3GPP.

Wireless communication systems in 3GPP.

Consider the simplified wireless communication system illustrated in FIG. 2 with a UE 102 which communicates with one or multiple access nodes 103-104, which in turn is connected to a network node 106. The access nodes 103-104 are part of the radio access network 100. FIG. 2 shows a simplified wireless communication system.

For wireless communication systems pursuant to 3GPP, EPS, also referred to as LTE or 4G, standard specifications, such as specified in 3GPP TS 36.300 v. 17.0.0 and related specifications, the access nodes 103-104 corresponds typically to an Evolved NodeB (eNB) and the network node 106 corresponds typically to either a Mobility Management Entity (MME) and/or a Serving Gateway (SGW). The eNB is part of the radio access network 100, which in this case is the E-UTRAN, while the MME and SGW are both part of the EPC network. The eNBs are inter-connected via the X2 interface, and connected to EPC via the S1 interface, more specifically via S1-C to the MME and S1-U to the SGW.

For wireless communication systems pursuant to 3GPP 5G System, 5GS, also referred to as NR or 5G, standard specifications, such as specified in 3GPP TS 38.300 and related specifications, on the other hand, the access nodes 103-104 corresponds typically to an 5G NodeB (gNB) and the network node 106 corresponds typically to either a Access and Mobility Management Function (AMF) and/or a User Plane Function (UPF). The gNB is part of the radio access network 100, which in this case is the Next Generation Radio Access Network (NG-RAN), while the AMF and UPF are both part of the 5G Core Network (5GC). The gNBs are inter-connected via the Xn interface, and connected to 5GC via the NG interface, more specifically via NG-control (C) to the AMF and NG-user (U) to the UPF.

To support fast mobility between NR and LTE and avoid change of core network, LTE eNBs can also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

### Mobility in RRC_CONNECTED in LTE and NR.

Mobility in RRC_CONNECTED state is also known as handover. The purpose of handover is to move the UE, due to, e.g., mobility, from a source access node using a source radio connection, also known as source cell connection, to a target access node, using a target radio connection, also known as target cell connection. The source radio connection is associated with a source cell controlled by the source access node. The target radio connection is associated with a target cell controlled by the target access node. In other words, during a handover, the UE moves from the source cell to a target cell. Sometimes the source access node or the source cell is referred to as the “source”, and the target access node or the target cell is sometimes referred to as the “target”.

In some cases, the source access node and target access node are different nodes, such as different eNBs or gNBs. These cases are also referred to as inter-node handover, inter-eNB handover or inter-gNB handover. In other cases, the source access node and target access node are the same node, such as the same eNB and gNB. These cases are also referred to as intra-node handover, intra-eNB handover or intra-gNB handover and covers the case when source and target cells are controlled by the same access node. In yet other cases, handover is performed within the same cell, and thus also within the same access node controlling that cell, —these cases are also referred to as intra-cell handover.

It should therefore be understood that the source access node and target access node refer to a role served by a given access node during a handover of a specific UE. For example, a given access node may serve as source access node during handover of one UE, while it also serves as the target access node during handover of a different UE. And, in case of an intra-node or intra-cell handover of a given UE, the same access node serves both as the source access node and target access node for that UE.

An RRC_CONNECTED UE in E-UTRAN or NG-RAN can be configured by the network to perform measurements of serving and neighbor cells and based on the measurement reports sent by the UE, the network may decide to perform a handover of the UE to a neighbor cell. The network then sends a Handover Command message to the UE (in LTE an RRConnectionReconfiguration message with a field called mobilityControlInfo and in NR an RRCReconfiguration message with a reconfigurationWithSync field).

These reconfigurations are actually prepared by the target access node upon a request from the source access node, over X2 or S1 interface in case of EUTRA-EPC or Xn or NG interface in case of NG-RAN-5GC, and takes into account the existing radio resource control (RRC) configuration and UE capabilities as provided in the request from the source access node and its own capabilities and resource situation in the intended target cell and target access node. The reconfiguration parameters provided by the target access node contains, for example, information needed by the UE to access the target access node, e.g., random access configuration, a new cell-radio network temporary identifier (C-RNTI) assigned by the target access node and security parameters enabling the UE to calculate new security keys associated with the target access node so the UE can send a Handover Complete message, in LTE an RRConnectionReconfiguratioComplete message and in NR an RRCReconfigurationComplete message, on signalling radio bearer one (SRB1) encrypted and integrity protected based on new security keys upon accessing the target access node.

FIG. 3 summarizes the signalling flow between UE, source access node (also known as source gNB, source eNB or source cell) and target access node (also known as target gNB, target eNB or target cell) during a handover procedure, using LTE as example. FIG. 3 shows Handover (HO) in LTE

### User Plane Handling During Handover.

Depending on the required quality of service (QOS), either a seamless or a lossless handover is performed as appropriate for each user plane radio bearer, as explained in the following subsections.

### Seamless Handover.

Seamless handover is applied for user plane radio bearers mapped on radio link control (RLC) Unacknowledged Mode (UM). These types of data are typically reasonably tolerant of losses but less tolerant of delay, e.g. voice services. Seamless handover is therefore designed to minimize complexity and delay but may result in loss of some packet data convergence protocol (PDCP) service data units (SDU).

At handover, for radio bearers to which seamless handover applies, the PDCP entities including the header compression contexts are reset, and the COUNT values are set to zero. As a new key is anyway generated at handover, there is no security reason to maintain the COUNT values. PDCP SDUs in the UE for which the transmission has not yet started will be transmitted after handover to the target access node. In the source access node, PDCP SDUs that have not yet been transmitted can be forwarded via the X2/Xn interface to the target access node. PDCP SDUs for which the transmission has already started but that have not been successfully received will be lost. This minimizes the complexity because no context, i.e. configuration information, has to be transferred between the source access node and the target access node at handover.

### Lossless Handover

Based on the secondary node (SN) that is added to PDCP Data PDUs it is possible to ensure in-sequence delivery during handover, and even provide a fully lossless handover functionality, performing retransmission of PDCP SDUs for which reception has not yet been acknowledged prior to the handover. This lossless handover function is used mainly for delay-tolerant services such as file downloads where the loss of one PDCP SDU can result in a drastic reduction in the data rate due to the reaction of the Transmission Control Protocol (TCP).

Lossless handover is applied for user plane radio bearers that are mapped on RLC Acknowledged Mode (AM). When RLC AM is used, PDCP SDUs that have been transmitted but not yet been acknowledged by the RLC layer are stored in a retransmission buffer in the PDCP layer.

In order to ensure lossless handover in the DL, the source access node forwards the DL PDCP SDUs stored in the retransmission buffer as well as fresh DL PDCP SDUs received from the gateway to the target access node for (re-)transmission. The source access node receives an indication from the core network gateway (SGW in LTE/EPC, UPF in LTE/5GC and NR) that indicates the last packet sent to the source access node (a so called “end marker” packet). The source access node also forwards this indication to the target access node 104 so that the target access node knows when it can start transmission of packets received directly from the gateway.

In order to ensure lossless handover in the UL, the UE retransmits the UL PDPC SDUs that are stored in the PDCP retransmission buffer in the target access node. The retransmission is triggered by the PDCP re-establishment that is performed upon reception of the handover command. The source access node, after decryption and decompression, will forward all PDCP SDUs received out of sequence to the target access node. Thus, the target access node 104 can reorder the PDCP SDUs received from the source access node 103 and the retransmitted PDCP SDUs received from the UE based on the PDCP SNs which are maintained during the handover, and deliver them to the gateway in the correct sequence.

An additional feature of lossless handover is so-called selective re-transmission. In some cases it may happen that a PDCP SDU has been successfully received, but a corresponding RLC acknowledgement has not. In this case, after the handover, there may be unnecessary retransmissions initiated by the UE or the target access node based on the incorrect status received from the RLC layer. In order to avoid these unnecessary retransmissions a PDCP status report can be sent from the target access node to the UE and from the UE to the target access node. Whether to send a PDCP status report after handover is configured independently for each radio bearer and for each direction.

### MRO in 3GPP and Rel. 17 Enhancements.

Seamless handovers are a key feature of 3GPP technologies. Successful handovers ensure that the UE moves around in the coverage area of different cells without causing too many interruptions in the data transmission. However, there will be scenarios when the network fails to handover the UE to the ‘correct’ neighbor cell in time and in such scenarios the UE will declare the radio link failure (RLF) or Handover Failure (HOF).

Upon HOF and RLF, the UE may take autonomous actions, i.e. trying to select a cell and initiate reestablishment procedure so that we make sure the UE is trying to get back as soon as it can, so that it can be reachable again. The RLF will cause a poor user experience as the RLF is declared by the UE only when it realizes that there is no reliable communication channel, e.g. radio link, available between itself and the network. Also, reestablishing the connection requires signalling with the newly selected cell, such as random access procedure, RRC Reestablishment Request, RRC Reestablishment RRC Reestablishment Complete, RRC Reconfiguration and RRC Reconfiguration Complete, and adds some latency, until the UE can exchange data with the network again.

According to the specifications (3GPP TS 36.331 v.17.0.0), the possible causes for the radio link failure could be one of the following:
1) Expiry of the radio link monitoring related timer T310;
2) Expiry of the measurement reporting associated timer T312 (not receiving the handover command from the network within this timer's duration despite sending the measurement report when T310 was running);
3) Upon reaching the maximum number of RLC retransmissions;
4) Upon receiving random access problem indication from the medium access control (MAC) entity;

As RLF/HOF leads to reestablishment which degrades performance and user experience, it is in the interest of the network to understand the reasons for RLF and try to optimize mobility related parameters, e.g., trigger conditions of measurement reports, to avoid later RLFs. Before the standardization of MRO related report handling in the network, only the UE was aware of some information associated with how the radio quality looked like at the time of RLF, what is the actual reason for declaring RLF etc. For the network to identify the reason for the RLF, the network needs more information, both from the UE and also from the neighboring base stations. Hence, the RLF-Report containing information from the UE can be useful for the network for the sake of performance optimization. The RLF-Report can be retrieved by any network node, and transmitted to the cell in which the RLF was experienced as well as to the previous primary cell (PCell). For the case of the handover failure, the UE will include the target PCell of the HO, as well as the source PCell of the HO.

Based on the RLF report from the UE and the knowledge about which cell did the UE reestablished itself, the original source cell can deduce whether the RLF was caused due to a coverage hole or due to handover associated parameter configurations. If the RLF was deemed to be due to handover associated parameter configurations, the original serving cell can further classify the handover related failure as too-early, too-late or handover to wrong cell classes. On the basis of this classification, the original serving cell can properly tune handover parameters and initiate certain measurement reports to avoid/limit the occurrences of RLF/HOF.

As an enhancement to MRO in Rel. 17, 3GPP is going to introduce the successful HO Report (SHR). Unlike the RLF report which is used, as described above, to report the RLF or Handover failure experienced by the UE, the SHR is used by the UE to report various information associated with successful HO. The successful HO will not be reported always at every HO, but only when certain triggering conditions are fulfilled. For example, if while doing HO, the T310/T312/T304 timers exceed a certain threshold, then the UE shall store information associated with this HO. Similarly, in case the HO was a dual active protocol stacks (DAPS) HO, and the UE succeeded with it, but an RLF was experienced in the source cell while doing the DAPS HO, then the UE stores information associated with this DAPS HO. When storing the successful handover report, the UE may include various information to aid the network to optimize the handover, such as measurements of the neighbouring cells, the fulfilled condition that triggered the successful handover report, e.g., threshold on T310 exceeded, specific RLF issue in the source while doing DAPS HO, etc.

The SHR can be configured by a certain serving cell, and when triggering conditions for SHR logging are fulfilled, the UE stores this information until the network (NW) requests it. In particular, the UE may indicate availability of SHR information in certain RRC message, such as RRCReconfigurationComplete, RRCReestablishmentComplete, RRCSetupComplete, RRCResumeComplete, and the network may request such information via the UEInformationRequest message, upon which the UE transmits the stored SHR in the UEInformationResponse message.

### SUMMARY

As part of developing embodiments herein one or more problems have been identified. The UE may report SHR and a RLF after execution of a mobility procedure e.g., handover or an RRC reconfiguration with sync procedure. That is because the UE may succeed with the handover to a target cell, but after the successful HO, the UE may slightly after experience an RLF in the same cell.

It would be important for the network to be able to figure out whether a received SHR and RLF-Report are in fact associated with the same HO. That is because whenever an SHR or RLF-Report are received, the network may perform some HO parameter optimization. Hence if for the same HO, an SHR and RLF-Report are received, the network may perform some different actions.

One way to perform this correlation between SHR and RLF-Report is to leverage on the C-RNTI, included in the SHR, assigned by the target cell of the HO, and on the C-RNTI, included in the RLF-Report, assigned at the moment of the RLF. If the C-RNTI included in the SHR is the same as the one included in the RLF-Report, and also if the target primary cell (PCell) of the HO, included in the SHR, is the same as the PCell at the moment of experiencing RLF, included in the RLF-Report, then the network can conclude that the SHR and the RLF-Report are associated with the same UE and to the same HO.

However, the source cell of the HO may not be capable of performing such a correlation, because the C-RNTI included in the SHR and in the RLF-Report is assigned by the target cell. The source cell can conclude that the SHR and the RLF-Report are associated with an HO to a specific target cell, but that would require the source cell to store the first received report, i.e., RLF-Report (or SHR), and the C-RNTI included therein, so that when the second report, i.e., SHR (or RLF-Report), is received the source cell would be able to perform the correlation. This may increase the complexity of the source cell, especially because the source cell cannot know whether the UE experienced an RLF in the target cell, or if it generated an SHR. Additionally, the source cell may not be able to conclude whether SHR and the RLF-Report are actually associated with the same UE, because a given C-RNTI can be re-assigned by the target cell to different UEs, and the source cell cannot obviously know whether a certain C-RNTI included in the RLF-Report is really associated with the same UE.

An object of embodiments herein is to provide a mechanism that handles communication in the wireless communication network in an efficient and improved manner.

According to an aspect the object is achieved by providing a method performed by a first network node for handling communication in a wireless communication network. The first network node obtains a first report and/or a second report relating to radio performance and/or HO, such as a RLF report or a SHR, of a UE. The first network node transmits to a second network node one or more indication messages such as a first indication message, and/or a second indication message, wherein an indication message is associated with the first report and the second report. The indication message may be transmitted to the second network node hosting the previous PCell in case of RLF-Report, or the source PCell of a HO, in case of SHR. Thus, the first network node may receive a first report and/or a second report relating to radio performance or a handover of a UE in the wireless communication network. The first network node transmits a first indication message indicating that the second report might be received for the UE indicating same executed HO of the UE and/or a second indication message indicating that the first report for the same executed HO was previously received for the UE.

According to another aspect the object is achieved by providing a method performed by a second network node for handling communication in a wireless communication network. The second network node receives, from a first network node, one or more indication messages such as a first indication message, and/or a second indication message, wherein the indication message is associated with a first report and a second report relating to radio performance or a handover of a UE in the wireless communication network. The second network node may be hosting the previous PCell in case of RLF-Report, or the source PCell of a HO, in case of SHR.

According to yet another aspect the object is achieved by providing a first network node for handling communication in a wireless communication network. The first network node is configured to obtain a first report and/or a second report relating to radio performance and/or HO, such as a RLF report or a SHR, of a UE. The first network node is configured to transmit, to a second network node, one or more indication messages such as a first indication message, and/or a second indication message, wherein an indication message is associated with the first report and the second report. The indication message may be transmitted to the second network node hosting the previous PCell in case of RLF-Report, or the source PCell of a HO, in case of SHR.

According to still another aspect the object is achieved by providing a second network node for handling communication in a wireless communication network. The second network node is configured to receive one or more indication messages such as the first indication message, and/or the second indication message, wherein the indication message is associated with the first report and the second report relating to radio performance or a handover of a UE in the wireless communication network. The second network node may be hosting the previous PCell in case of RLF-Report, or the source PCell of a HO, in case of SHR.

It is furthermore provided herein a computer program product comprising instructions, which, when executed on at least one processor, cause the at least one processor to carry out any of the methods herein, as performed by the first or second network node, respectively. It is additionally provided herein a computer-readable storage medium, having stored thereon a computer program product comprising instructions which, when executed on at least one processor, cause the at least one processor to carry out any of the methods herein, as performed by the first or second network node, respectively.

Embodiments herein disclose methods defined in a first network node hosting the cell in which a certain UE experienced an RLF, and in a second network node hosting the cell in which the UE was connected when it executed the last HO before experiencing the RLF. The first network node obtains such as receives a first and/or a second report from the UE, or from any other network node fetching the first and second report from said UE, wherein the first and second report can be a RLF-Report and/or a SHR report. The first network node may determine whether the first and second report are associated with the same UE and to the same last HO that the UE executed before experiencing the RLF. The first network node may then inform the second network node whether the first and second report are associated with the same UE and to the same last HO that the UE executed before experiencing the RLF. The first network node may also provide a way to link the first and second reports.

Thus, embodiments herein enable a correlation between the SHR and the RLF report through an indication message to be exchanged between the first network node in which the RLF occurred, and the second network node to which the UE was connected when it executed the last HO before experiencing the RLF. Upon enabling such correlation at the network side, a network node would be able to take a correct action to avoid radio link failures or sub-optimal execution of the handovers in the future. Note that without such correlation, the network may take set of contradicting actions that are avoided by the provided solution and hence, the communication is improved in the wireless communication network.

### BRIEF DESCRIPTION OF THE DRAWINGS

Embodiments will now be described in more detail in relation to the enclosed drawings, in which:

FIG. 1 is a schematic overview depicting ramifications of Self-Configuration/Self-Optimization functionality according to prior art;

FIG. 2 is a schematic overview depicting an architecture according to prior art;

FIG. 3 is a schematic overview depicting a signalling scheme according to prior art;

FIG. 4 is a schematic overview depicting a wireless communication network according to embodiments herein;

FIG. 5 is a schematic combined flowchart and signalling scheme according to embodiments herein;

FIG. 6 is a schematic overview depicting a flowchart of a method performed by a first network node according to some embodiments herein;

FIG. 7 is a schematic overview depicting a flowchart of a method performed by a second network node according to some embodiments herein;

FIG. 8a-8b are block diagrams depicting a first network node according to some embodiments herein;

FIG. 9a-9b are block diagrams depicting a second network node according to some embodiments herein;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12-15 are flowcharts illustrating methods implemented in a communication system including a host computer, a base station and a user equipment.

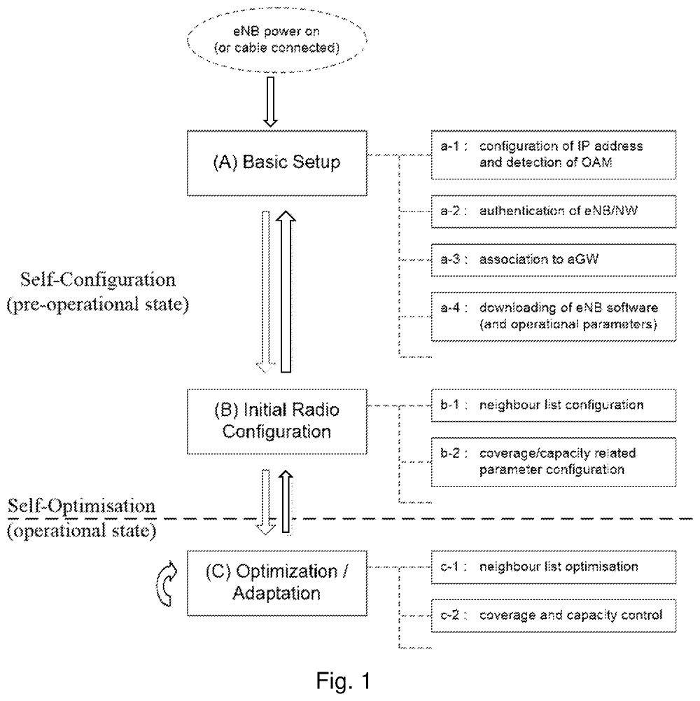

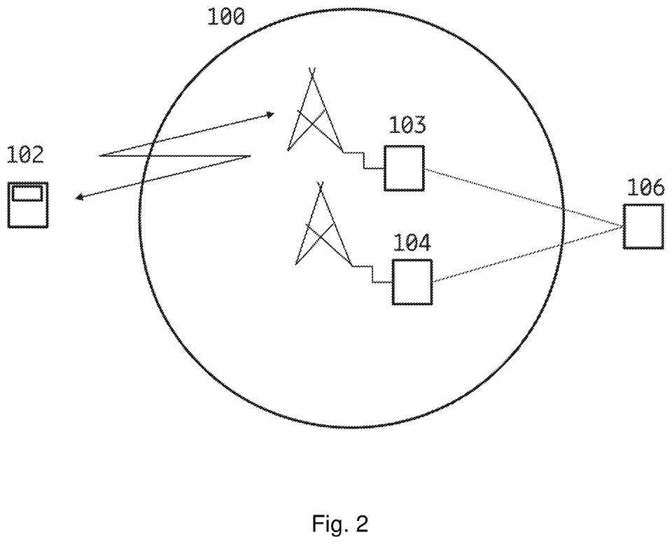

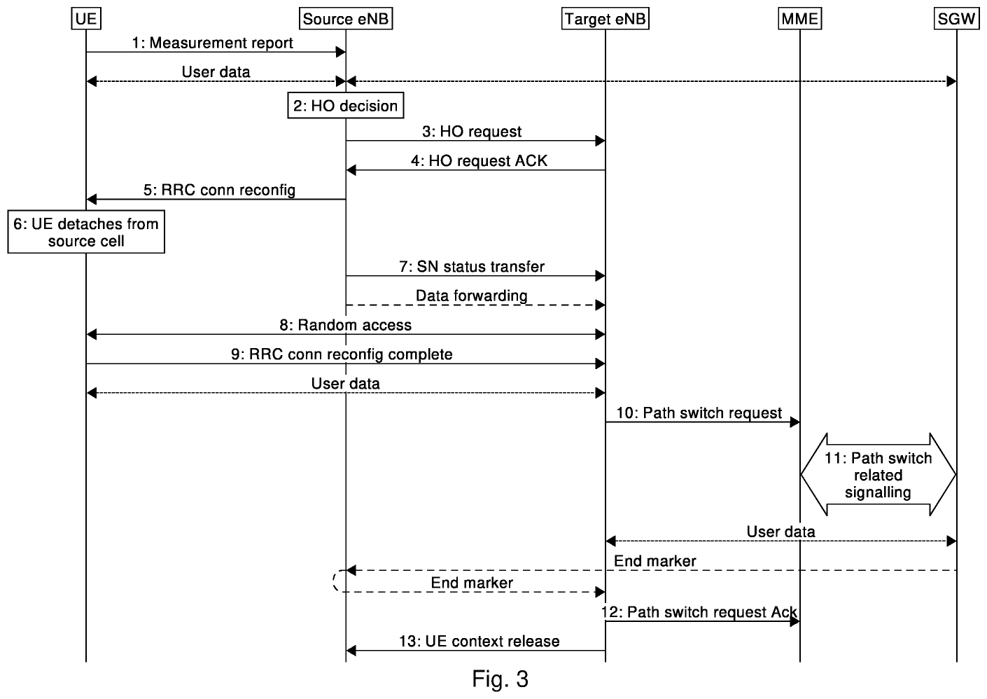

### DETAILED DESCRIPTION

Embodiments herein are described in the context of 5G/NR but the same concept can also be applied to other wireless communication system such as 4G/LTE. Embodiments herein may be described within the context of 3GPP NR radio technology (3GPP TS 38.300 V15.2.0 (2018-06)), e.g. using gNB as the radio network node. It is understood, that the problems and solutions described herein are equally applicable to wireless access networks and UEs implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

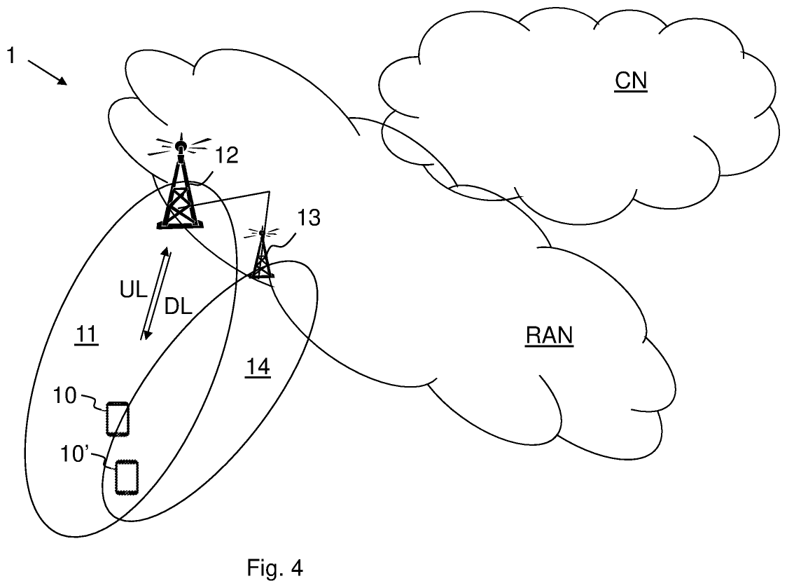

Embodiments herein relate to wireless communication networks in general. FIG. 4 is a schematic overview depicting a wireless communication network 1. The wireless communication network 1 comprises, e.g., one or more RANs and one or more CNs. The wireless communication network 1 may use one or a number of different technologies, such as Wi-Fi, LTE, LTE-Advanced, NR, WCDMA, Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in 5G systems, however, embodiments are also applicable in further development of the existing communication systems such as e.g. a WCDMA or a LTE system.

In the wireless communication network 1, wireless devices e.g. a UE 10, and a second UE 10′, such as a mobile station, a non-access point (non-AP) station (STA), a STA, a user equipment and/or a wireless terminal, communicate via one or more Access Networks (AN), e.g. RAN, to one or more CNs. It should be understood by the skilled in the art that “UE” is a non-limiting term which means any terminal, wireless communication terminal, user equipment, Machine Type Communication (MTC) device, Device to Device (D2D) terminal, internet of things (IoT) operable device, or node e.g. smart phone, laptop, mobile phone, sensor, relay, mobile tablets or even a small base station capable of communicating using radio communication with a network node within an area served by the network node.

The communication network 1 comprises a first network node 12 providing e.g. radio coverage over a geographical area, a first service area 11 i.e. a first cell, of a radio access technology (RAT), such as NR, LTE, Wi-Fi, WiMAX or similar. The first network node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The first network node 12 may alternatively or additionally be a controller node or a packet processing node or similar. The first network node 12 may be referred to as target access node or network node wherein the first service area 11 may be referred to as a target cell, or primary cell, and the first network node communicates with the UE 10 in form of DL transmissions to the UE 10 and UL transmissions from the UE 10. The first network node 12 may be a distributed node comprising a baseband unit and one or more remote radio units.

The communication network 1 comprises a second network node 13 providing e.g. radio coverage over a geographical area, a second service area 14 i.e. a second cell, of a RAT, such as NR, LTE, Wi-Fi, WIMAX or similar. The second network node 13 may be a central unit of a base station a so called CU, a transmission and reception point, a computational server, a base station e.g. a network node such as a satellite, a WLAN access point or an AP STA, an access node, an access controller, a radio base station such as a eNB, eNodeB, a gNB, a base transceiver station, a baseband unit, an Access Point Base Station, a base station router, a transmission arrangement of a radio base station, a stand-alone access point or any other network unit or node depending e.g. on the radio access technology and terminology used. The second network node 13 may be referred to as source access node or network node wherein the second service area 14 may be referred to as a source cell, or previous primary cell, and the second network node communicates with the UE 10 in form of DL transmissions to the UE 10 and UL transmissions from the UE 10. The second network node 13 may be a distributed node comprising a baseband unit and one or more remote radio units.

It should be noted that a service area may be denoted as cell, beam, beam group or similar to define an area of radio coverage. It should further be noted that the first and second cell may be provided by the same first network node 12.

Embodiments herein disclose methods defined in the first network node 12 hosting the cell 11 in which the UE 10 experienced an RLF, and in the second network node 13 hosting the cell 14 in which the UE 10 was connected when it executed the last HO before experiencing the RLF. The first network node 12 obtains, for example, receives a first and/or second report from the UE 10, or from any other network node fetching the first and second report from said UE, wherein the first and second report can be the RLF-Report or the SHR report.

The first network node 12 may determine whether the first and second report are associated with the same UE and the same last HO that the UE executed before experiencing the RLF. The first network node 12 informs, with one or more indication messages, the second network node 13 whether the first and second report are associated with the same UE and with the same last HO that the UE 10 executed before experiencing the RLF. The first network node 12 may also provide a way to link the first and second reports.

Embodiments herein may relate to one or more of the following:
An embodiment defined for the first network node 12 hosting the cell in which an RLF occurred for the UE 10, and comprising the following methods:
   Determining that a first received SON report, i.e., RLF-Report (or SHR), and second received SON report, i.e., SHR (or RLF-Report) includes information indicating that the last executed HO before the RLF was the same and that they are associated with the same UE 10.
   Upon performing the above determination, indicating in a first indication message to the second network node 13 hosting the cell 14 to which the UE 10 was connected when it executed the last HO before the RLF, that a second report might be received for the concerned UE 10 indicating the same last executed HO. Optionally, insert an HO identifier to the first indication message, uniquely identifying the HO for this UE 10.
   Upon performing the above determination, indicating in a second indication message to the second network node 13 hosting the cell to which the UE was connected when it executed the last HO before the RLF, that a first report indicating the same last executed HO was previously received for the concerned UE. Optionally, insert the same HO identifier described above to the second indication message, uniquely identifying the HO for this UE 10.
An embodiment defined for the second network node 13 hosting the cell to which the UE 10 was connected when it executed the last HO, and comprising the following methods:
   Receiving a first and second SON reports from any network node fetching them from the UE 10.
   Receiving a first indication message from the first network node 12 associated with the first report, and determining whether to take into account in the SON optimization policies the content of the first report, based on the information included in the first indication message related to the possible reception from the UE 10 of second report associated with the same last executed HO. Optionally, receiving an HO identifier in the first indication message, uniquely identifying the HO for this UE 10.
   Receiving a second indication message from the first network node 12 associated with the second report, and determining whether to take into account in the SON optimization policies the content of the second report or both first and second report, based on the information included in the second indication message. The information included in the second indication message indicates whether the second report is associated with the same UE 10 and to the same HO as the first report.

Embodiments herein enable a correlation between the first and second reports such as SHR and the RLF report through information to be exchanged between the first network node 12 in which the RLF occurred and the second network node 13 to which the UE 10 was connected when it executed the last HO before experiencing the RLF. Upon enabling such correlation at the network side, the network node would be able to take a correct action to avoid radio link failures or sub-optimal execution of the handovers in the future. Note that without such correlation network may take set of contradicting actions that are avoided by the provided solution.

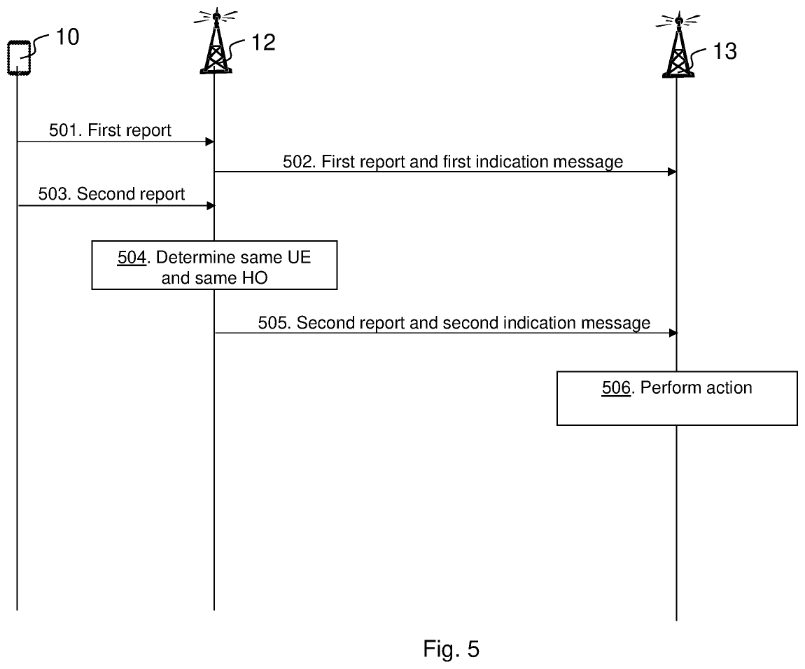

FIG. 5 is a schematic combined flowchart and signalling scheme depicting some embodiments herein.

Action 501. The first network node 12 obtains, such as receives, the first report relating to radio performance or handover such as a RLF report or a SHR from the UE 10 or from another network node.

Action 502. The first network node 12 may transmit to the second network node 13, the first report and a first indication message indicating that a second report associated with the same HO for the same UE can be expected or has already been sent. The first report and the first indication message may be comprised in a same message or comprised in different messages.

Action 503. The first network node 12 obtains, such as receives, the second report relating to radio performance or handover such as a RLF report or a SHR from the UE 10 or from another network node.

Action 504. The first network node 12 may determine that the first report and the second report are associated with the same UE and same HO.

Action 505. The first network node 12 may transmit to the second network node 13, the second report and a second indication message indicating that the second report is associated with the same HO for the same UE. The second report and the second indication message may be comprised in a same message or be comprised in different messages.

Action 506. The second network node 13 may determine to perform an action based on the received first and second report and the first and/or the second indication message. The second network node 13 may initiate or perform a correlation to correlate the first and the second report based on the first and/or second indication message. For example, the second network node 13 may trigger, based on the correlation, an operation to take an action to avoid radio link failures or sub-optimal execution of the handovers in the future.

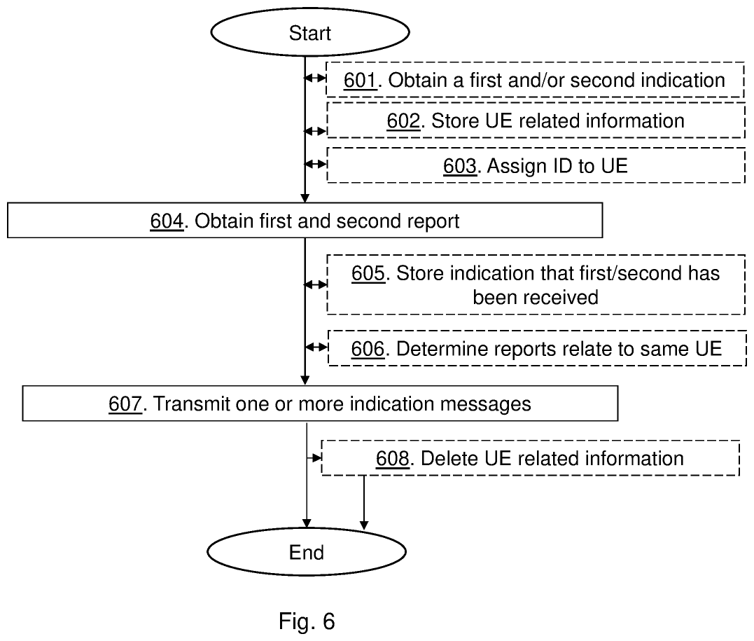

The method actions performed by the first network node 12, such as a first radio network node, for handling communication in the wireless communications network 1 according to embodiments herein will now be described with reference to a flowchart depicted in FIG. 6. The actions do not have to be taken in the order stated below. Dashed boxes indicate optional features.

Action 601. The first network node 12 may obtain a first indication and/or a second indication. For example, the first network node 12 may obtain an RLF indication of the UE 10 in the first cell, and/or may obtain a SHR indication of the UE 10 to the first cell.

Action 602. The first network node 12 may store UE related information, such as UE context, for the UE 10.

Action 603. The first network node 12 may assign an identity to the UE 10, wherein the identity is different than an identity of another UE.

Action 604. The first network node 12 obtains a first report and/or a second report relating to radio performance and/or HO such as a RLF report or a SHR of the UE 10.

Action 605. The first network node 12 may store an indication that for that identity, i.e., the UE 10, included in the received first report, the first report and/or the second report has been received. The first network node 12 may also store a previous PCell indication included in the first report, or a source PCell indication included in the first report, or an HO identifier uniquely identifying the HO for the UE 10.

Action 606. The first network node 12 may determine that the first and second report relates to the same UE based on C-RNTI in respective report.

Action 607. The first network node 12 transmits, to the second network node 13, one or more indication messages such as a first indication message, and/or a second indication message, wherein an indication message is associated with the first report and the second report. The one or more indication messages may comprise a HO identifier indication, uniquely identifying a HO for the UE 10. The indication message may be transmitted to the second network node 13 hosting the previous PCell in case of RLF-Report, or the source PCell of a HO, in case of SHR. The second indication message associated with the second report may be transmitted to the second network node 13 with an indication that the first report and the second report are for the same UE. Furthermore, the first network node 12 may transmit the first report and the second report to the UE 10. The indication message may comprise an indication that indicates that a 2nd mobility report associated to the same HO for the same UE can be expected or has already been sent.

Action 608. The first network node 12 may delete the UE related information such as UE context once both the first and second report, i.e., RLF-Report and the SHR, are received for the UE 10, or when a timer has expired.

Thus, methods for the first network node 12, which hosts the cell 11 in which the UE experiences the RLF.

The first network node 12 is defined as the node hosting the cell 11 in which the UE 10 experiences an RLF after performing a successful handover to the cell. This embodiment comprises one or more of the following actions:
(Optionally) Detecting that for a certain UE 10 an RLF has been experienced, and that for such UE 10 an SHR was generated for the handover to said hosting cell 11.
For the case of RLF, this action can be performed by the first network node 12 implementation by monitoring UE status, and timers to declare that the UE 10 has left the cell coverage.
For the case of SHR, this action can be determined by receiving an RRCReconfigurationComplete including an indication from the UE 10 that an SHR is available at the UE 10, and by knowing that the UE 10 was configured with an SHR configuration to be applied for the specific handover to the cell.
(Optionally) Storing the UE context or part of the UE context associated said UE 10 which is declared as experiencing RLF, or as generating an SHR. For example, the UE 10 may store the C-RNTI associated with this UE 10, the previous/source PCell 14 to which the UE was connected previously, and an HO identifier uniquely identifying the HO for this UE. This action can be performed for the UE 10 for which an RLF is detected in the cell 11 following the detection of the availability of the SHR as per the action above
(Optionally) Assigning to a second UE 10′ which connects to the cell 11 a C-RNTI different from the C-RNTI assigned to the UE 10 for which an RLF was detected.
The action may be performed only if the first network node has not received yet the RLF-Report and the SHR including the C-RNTI of the UE 10.
The action may be performed only if the first network node 12 determines that the UE 10 has been configured to log SHR for the handover to the target cell 11 in which the RLF is detected.
(Optionally) Receiving the first report, i.e. the RLF-Report or SHR, and store information that for the C-RNTI included in the received first report, the first report, i.e. RLF-Report, or SHR, has been received. The first network node 12 may also store information such as the previous PCell indication included in the first report, if the RLF-Report is received, or the source PCell indication included in the first report, if the SHR is received, or an HO identifier uniquely identifying the HO for this UE.
If UE context was performed, such information can be appended to the stored UE context. Otherwise, such information can be included in a local variable.
Transmitting the first indication message associated with the first report, i.e., RLF-Report, SHR, to the second network node 13 hosting the previous PCell 14, in case of RLF-Report, or the source PCell 11 of the HO, in case of SHR.
In case the first report is the RLF-Report, i.e. if the RLF-Report was received by the first network node 12 before the SHR, and if the first network node 12 knows that the concerned UE 10 was configured to log the SHR as per the action 601, the first network node 12 may transmit in the first indication message an indication to the second network node indicating that an SHR, i.e. second report, is expected for the concerned UE 10.
In case the first report is the SHR, i.e., if the SHR was received by the first network node 12 before the RLF-Report, and if the first network node 12 knows that the concerned UE 10 experienced an RLF in the cell 11, e.g., by checking that the C-RNTI included in the SHR is the same as the C-RNTI stored in action 602, and that the previous PCell included in the RLF-Report is the same as the source PCell included in the SHR, the first network node 12 may transmit in the first indication message an indication to the second network node 13 indicating that an RLF-Report, second report, is expected for the concerned UE 10.
(Optionally) The first indication message may contain an HO identifier uniquely identifying the HO for this UE.
In case the first report is an RLF report, the first indication message may be a Failure Indication message or an Handover Report message. In case the first report is an SHR, the second indication message may be an Access and Mobility Indication message.
Receiving the second report, i.e., SHR (RLF-Report) and determining that for the received second report SHR (RLF-Report) a first report, i.e. RLF-Report (SHR) associated with the same UE 10 has been already received. This action can be performed by comparing the C-RNTI indication, included in the received second report, with the C-RNTI which was stored by the first network node upon receiving the first report RLF-Report. Further, the first network node 12 may determine that the source PCell indication, if the second report is SHR, or the previous PCell indication, if the second report is RLF-Report, is the same as the previous (source) PCell indication, i.e. the cell 14, stored by the first network node 12 for the concerned UE 10.
Transmitting the second indication message associated with the second report, i.e. SHR (RLF-Report) to the second network node 13 hosting the source PCell, if the second report is SHR, or the previous PCell, if the second report is RLF-Report, and including an indication in the second indication message indicating that a first indication message associated with the same last executed HO and to the same UE was previously transmitted to the second network node 13.
(Optionally) Includes the HO identifier, stored with the UE Context as in action 602 or action 604, within the second indication message, uniquely identifying the HO for this UE 10.
In case the second report is an RLF report, the second indication message may be a Failure Indication message or an Handover Report message. In case the second report is an SHR, the second indication message may be an Access and Mobility Indication message.
Deleting the UE context stored as in action 602 or the information stored in action 604 once both the first and second report, i.e. RLF-Report and the SHR, are received for the concerned UE 10, or once a certain time has elapsed since the storing of the context/information.

This embodiment also includes a method according to which if the first or second report is an SHR, the first network node 12 may transmit the associated first or second indication message, only if the SHR indicates that the cause(s) triggering the SHR was/were configured by the second network node 13. For example, if the SHR indicates that the SHR was generated due to T310/T312 timer being above a threshold configured by the second network node 13, e.g. source node, the first network node 12, e.g. target node, may not transmit the corresponding indication message to the second network node 13. This method may also imply that if the SHR is the second report, the first network node 13 may indicate in the second indication message to the second network node 13 that an SHR was received but that the cause(s) generating the SHR was/were not configured by the second network node 13.

Some embodiments also include a method in which the transmission of the first and second indication message respectively, may be performed upon request of the second network node 13. For example, the second network node 13 upon receiving the first or second report from the first network node 12 fetching the report, may request to the first network node to provide information on whether the UE may have generated for the same HO both a SHR and an RLF-Report. For example, if the second network node 13 receives an SHR, it may request the first network node 12 to provide information on whether also an RLF report has been generated as a consequence of an RLF experienced in the target cell 11.

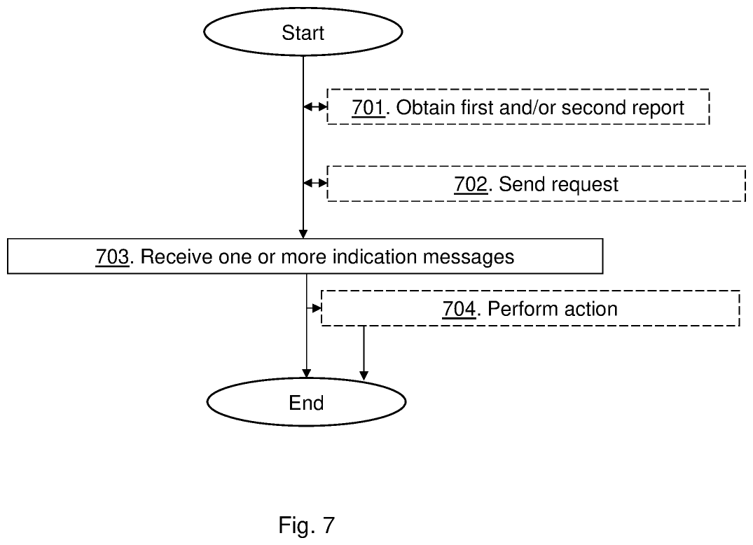

The method actions performed by the second network node 12, such as a second radio network node, for handling communication in the communication network 1 according to embodiments herein will now be described with reference to a flowchart depicted in FIG. 7. The actions do not have to be taken in the order stated below. Dashed boxes indicate optional features.

Action 701. The second network node 13 may obtain the first report and/or the second report relating to radio performance and/or HO such as a RLF report or a SHR of the UE 10. These reports may be obtained from the first network node 12 or another network node.

Action 702. The second network node 13 may send a request to the first network node 12, requesting whether a second report may be received associated with the same UE 10, or whether a first report has already been sent.

Action 703. The second network node 13 receives, from the first network node 12, the one or more indication messages such as the first indication message, and/or the second indication message, wherein the indication message is associated with the first report and the second report relating to radio performance and/or HO of the UE 10. The one or more indication messages may comprise the HO identifier indication, uniquely identifying a HO for the UE 10. The second network node 13 may be hosting the previous PCell in case of RLF-Report, or the source PCell of a HO, in case of SHR. The second indication message associated with the second report may comprise the indication that the first report and the second report are for the same UE and/or HO.

Action 704. The second network node 13 may then perform an action related to HO of the UE 10. The second network node 13 may initiate or perform the correlation to correlate the first and the second report based on the one or more indication messages such as the first and/or second indication message. The second network node 13 may take, or make a third network node take, into account the first report associated with the received first indication message for network parameters optimization, or discard the first report.

Methods for the second network node 13, which hosts the previous cell 14 to which the UE 10 was connected when it executed the last HO before experiencing the RLF.

The second network node 13 may be defined as the node hosting the cell 14 to which the UE 10 was connected when it executed the last HO before experiencing the RLF in the cell 11. This embodiment comprises one or more of the following actions:

The first report may be included in the first indication message. And the second report may be included in the second indication message.
Receiving a first report, i.e., RLF-Report (SHR) from any network node fetching the first report from the UE.
(Optionally) Transmitting to the first network node 12 the request on whether a second report may be received associated with the same UE. This request may include the C-RNTI assigned by the cell 11 hosted by the first network node 12, the cell identity of the cell 11 and of the cell 14, as indicated in the received first report.
Receiving a first indication message associated with a first report, i.e., RLF-Report (or SHR), from the first network node 12 and if the indication message includes an indication indicating that a second report is expected for the same UE 10 and (optionally) HO identifier uniquely identifying the HO for this UE 10, as per the method above, the second network node 13 may perform any of the following actions:
   Taking into account the first report associated with the received first indication message for network parameters optimization, e.g. the second network node 13 may use the first received report as input for a SON, or artificial intelligence (AI) or machine learning (ML) algorithm. The second network node 13 may also store information that for the UE 10 the first report has been received and taken into account.
   This action can be for example performed if the second network node 13 determines that the first report is an RLF-Report and that the RLF-Report shows that the RLF was not due to a too-early HO from the source cell 14 to the target cell 11, which implies that the reason of the RLF may be due to a wrong parameter setting at the second network node 13.
   Or:
   Storing the received first report and the HO identifier without taking it into account for network parameter optimization.
   This action can be for example performed if the second network node 13 determines that the first report is an RLF-Report and that the RLF-Report shows that the RLF was not due to a too-early HO from the source cell 14 to the target cell 11, which implies that the reason of the RLF may be due to a wrong parameter setting at the second network node 13.
   Discarding the received first report.
   This action of discarding can be for example performed if the second network node 13 determines that the first report is an RLF-Report and that the RLF-Report shows that the RLF was not due to a too-early HO from the source cell 14 to the target cell 11, which implies that the reason of the RLF may not be due to a wrong parameter setting at the second network node 13.

In case the first report is an RLF report, the first indication message may be a Failure Indication message or a Handover Report message. In case the first report is an SHR, the second indication message may be an Access and Mobility Indication message.
Receiving a second report, i.e. RLF-Report (SHR) from any network node fetching the second report from the UE 10.
(Optionally) Transmitting to the first network node 12 a request on whether a first report associated with the same UE was already received earlier. This request may include the C-RNTI assigned by the cell 11 hosted by the first network node, the cell identity of the cell 11 and of the cell 14, as indicated in the received second report.
Receiving a second indication message associated with the second report, i.e. SHR (RLF-Report), from the first network node 12, and if the indication message includes an indication indicating that the second report, i.e. SHR (RLF-Report), and the previously received first report are associated with the same UE 10 and to the same HO that the UE 10 executed before the RLF, then the second network node 13 may perform any of the following actions:
   Taking into account the second received report if the previously first received report was not taken into account for network parameters optimization.
   This action can be for example performed if the second network node 13 determines that the second report is an RLF-Report and that the RLF-Report shows that the RLF was due to a too-early HO from the source cell 14 to the target cell 11, which implies that the reason of the RLF may be due to a wrong parameter setting at the second network node 13.
   Taking jointly into account the first received report, if previously stored, and the second received report.
   For example, the second network node 13 may evaluate the most suitable network parameter optimization, based on the fact that for the same HO, the UE 10 generated a SHR and successively an RLF-Report.
   In particular, this action can be performed in case the received RLF-Report shows that a too-early HO from the source cell 14 to the target cell 11 occurred, which implies that the reason of the RLF may be due to a wrong parameter setting at the second network node 13.
   or:
   Discarding the second report, if the first report was already taken into account above.

### Example of a Possible Implementation in TS 38.423 Additions are Underlined and Bold

### Failure Indication and Handover Report Messages

### 9.1.3.16 Failure Indication

This message is sent by NG-RAN node₂ to indicate an RRC re-establishment attempt or a reception of an RLF Report from a UE that suffered a connection failure at NG-RAN node₁.
Direction: NG-RAN node₂→NG-RAN node₁.

| | | | | |
|---|---|---|---|---|
| | | | IE type and | Semantics |
| IE/Group Name | Presence | Range | reference | description |

| | | | |
|---|---|---|---|
| Message Type | M | 9.2.3.1 | |
| CHOICE Initiating | M | | |
| condition | | | |
| >RRC Reestab | | | |
| >>CHOICE RRC | M | | |
| Reestab Initiated | | | |
| Reporting | | | |
| >>>RRC Reestab | | | |
| Reporting without | | | |
| RLF Report | | | |
| >>>>Failure cell | M | 9.2.2.10 | Physical Cell |
| PCI | | | Identifier |
| >>>>Re- | M | Global NG-RAN | |
| establishment cell | | Cell Identity | |
| CGI | | 9.2.2.27 | |
| >>>>C-RNTI | M | BIT STRING (SIZE | C-RNTI |
| | | (16)) | contained in the |
| | | | RRCRe- |
| | | | establishment |
| | | | Request |
| | | | message (TS |
| | | | 38.331 [10]) |
| | | | or in the |
| | | | RRCConnection |
| | | | Reestablishment |
| | | | Request |
| | | | message (TS |
| | | | 36.331 [14]) |
| >>>>ShortMAC-I | M | BIT STRING (SIZE | ShortMAC-I |
| | | (16)) | contained in the |
| | | | RRCRe- |
| | | | establishment |
| | | | Request |
| | | | message (TS |
| | | | 38.331 [10]) |
| | | | or in the |
| | | | RRCConnection |
| | | | Reestablishment |
| | | | Request |
| | | | message (TS |
| | | | 36.331 [14]) |
| >>>>RRC Conn | O | ENUMERATED | |
| Reestab Indicator | | (reconfigurationFailure, | |
| | | handoverFailure, | |
| | | othlailure, . . . ) | |
| >>>RRC Reestab | | | |
| Reporting with RLF | | | |
| Report | | | |
| >>>>UE RLF | M | 9.2.2.59 | nr-RLF-Report-r16 |
| Report Container | | | IE contained in the |
| | | | UEInformationResponse |
| | | | message |
| | | | (TS 38.331 [10]) |
| | | | or RLF-Report-r9 |
| | | | IE contained in the |
| | | | UEInformationResponse |
| | | | message |
| | | | (TS 36.331 [14]) |
| >RRC Setup | | | |
| >>CHOICE RRC | M | | |
| Setup Initiated | | | |
| Reporting | | | |
| >>>RRC Setup | | | |
| Reporting with RLF | | | |
| Report | | | |
| >>>>UE RLF | M | 9.2.2.59 | nr-RLF-Report- |
| Report Container | | | r16 IE contained |
| | | | in the |
| | | | UEInformationResponse |
| | | | message |
| | | | (TS 38.331 [10]) |
| | | | or RLF-Report-r9 |
| | | | IE contained in |
| | | | the |
| | | | UEInformationResponse |
| | | | message |
| | | | (TS 36.331 [14]) |
| Mobility Reports | O | ENUMERATED | Indicates that a |
| Correlation | | (expected, | 2^{nd} mobility |
| | | sent, . . . ) | report |
| | | | associated with |
| | | | the same HO for |
| | | | the same UE |
| | | | can be expected |
| | | | or has already |
| | | | been sent |
| Mobility Reports | O | BIT STRING (SIZE | Uniquely |
| Correlation ID | | (8)) | identify the HO |
| | | | for this UE |

### 9.1.3.17 Handover Report

This message is sent by NG-RAN node₁ to NG-RAN node₂ to report a handover failure event, or other critical mobility problem.
Direction: NG-RAN node₁→NG-RAN node₂.

| | | | IE type and | Semantics |
|---|---|---|---|---|
| IE/Group Name | Presence | Range | reference | description |
| Message Type | M | | 9.2.3.1 | |
| Handover | M | | ENUMERATED | |
| Report Type | | | (HO too early, | |
| | | | HO to wrong cell, | |
| | | | Inter-system | |
| | | | ping-pong. . . . ) | |
| Handover | M | | Cause | Indicates handover |
| Cause | | | 9.2.3.2 | cause employed for |
| | | | | handover from NG- |
| | | | | RAN node 2 |
| Source | M | | Global NG-RAN | NG-RAN CGI of |
| cell CGI | | | Cell Identity | source cell for |
| | | | 9.2.2.27 | handover |
| | | | | procedure (in NG- |
| | | | | RAN node 2) |
| Target | M | | Global NG-RAN | NG-RAN CGI of |
| cell CGI | | | Cell Identity | target cell for |
| | | | 9.2.2.27 | handover |
| | | | | procedure (in NG- |
| | | | | RAN node 1). |
| | | | | If the Handover |
| | | | | Report Type is set |
| | | | | to “Inter-system |
| | | | | ping-pong”, it |
| | | | | contains the target |
| | | | | cell of the inter |
| | | | | system handover |
| | | | | from the other |
| | | | | system to NG-RAN |
| | | | | node 1 cell |
| Re- | C-ifHandoverReportType | | Global Cell | CGI of cell where |
| establishment | HoToWrongCell | | Identity | UE attempted re- |
| cell | | | 9.2.2.73 | establishment or |
| CGI | | | | where UE |
| | | | | successfully re- |
| | | | | connected after the |
| | | | | failure |
| Target cell | C-ifHandoverReportType | | OCTET STRING | Encoded according |
| in E-UTRAN | Intersystempingpong | | | to Global Cell ID in |
| | | | | the Last Visited E- |
| | | | | UTRAN Cell |
| | | | | Information IE, as |
| | | | | defined in in TS |
| | | | | 36.413 [31] |
| Source cell | O | | BIT STRING | C-RNTI allocated at |
| C-RNTI | | | (SIZE (16)) | the source NG-RAN |
| | | | | node (in NG-RAN |
| | | | | node 2) |
| Mobility | O | | BIT STRING | Information |
| Information | | | (SIZE (32)) | provided in the |
| | | | | HANDOVER |
| | | | | REQUEST |
| | | | | message from NG- |
| | | | | RAN node 2. |
| UE RLF Report | O | | 9.2.2.59 | The UE RLF Report |
| Container | | | | Container IE |
| | | | | received in the |
| | | | | FAILURE |
| | | | | INDICATION |
| | | | | message. |
| CHO Configuration | O | | 9.2.2.76 | |
| Mobility Reports | O | | ENUMERATED | Indicates that |
| | | | (expected, | a 2^{nd} |
| Correlation | | | sent, . . . ) | mobility report |
| | | | | associated with |
| | | | | the same HO for |
| | | | | the same UE can |
| | | | | be expected or |
| | | | | has already been |
| | | | | sent |
| Mobility Reports | O | | BIT STRING | Uniquely identify |
| Correlation ID | | | (SIZE (8)) | the HO for this UE |

| Condition | Explanation |
|---|---|
| ifHandoverReportType HoToWrongCell | This IE shall be present if the Handover Report Type IE is set to the |
| | value “HO to wrong cell” |
| ifHandoverReportType | This IE shall be present if the Handover Report Type IE is set to the |
| Intersystempingpong | value “Inter-system ping-pong” |

### Access and Mobility Indication Message

### 9.1.3.25 Access and Mobility Indication

This message is sent by NG-RAN node₁ to transfer access and mobility related information to NG-RAN node₂.
Direction: NG-RAN node₁→NG-RAN node₂.

| | | | IE type and | Semantics | | Assig [symbol] |
|---|---|---|---|---|---|---|
| IE/Group Name | Presence | Range | reference | description | Criticality | Critic [symbol] |
| Message Type | M | | 9.2.3.1 | | YES | igno [symbol] |
| RACH Report List | | 0 . . . 1 | | | YES | igno [symbol] |
| >RACH Report List | | 1 . . . <maxnoofRACHReports> | | | EACH | igno [symbol] |
| Item | | | | | | |
| >>RACH Report | O | | OCTET STRING | RA-ReportList-r16 | YES | igno [symbol] |
| Container | | | | IE as defined in | | |
| | | | | subclause 6.2.2 in | | |
| | | | | TS 38.331 [10]. | | |
| >>UE Assistant | O | | NG-RAN node | | YES | igno [symbol] |
| Identifier | | | UE XnAP ID | | | |
| | | | 9.2.3.16 | | | |
| Successful HO Report | | 0 . . . 1 | | | YES | igno [symbol] |
| List | | | | | | |
| >Successful HO | | 1 . . . <maxnoofSuccessfulHOReports> | | | — | |
| Report List Item | | | | | | |
| >>Successful HO | O | | OCTET STRING | | — | |
| Report Container | | | | | | |
| >>Mobility Reports | O | | ENUMERATED | Indicates | | |
| Correlation | | | (expected, sent, . . . ) | that a 2^{nd} | | |
| | | | | mobility report | | |
| | | | | associated with | | |
| | | | | the same HO for | | |
| | | | | the same UE can | | |
| | | | | be expected or | | |
| | | | | has already been | | |
| | | | | sent | | |
| >>Mobility Reports | O | | BIT STRING | Uniquely identify | | |
| Correlation ID | | | (SIZE (8)) | the HO for this UE | | |

| Range bound | Explanation |
|---|---|
| maxnoofRACHReports | Maximum no. of RACH Reports, |
| | the maximum value is 64. |
| maxnoofSuccessfulHOReports | Maximum no. of Successful HO Reports, |
| | the maximum value is 64. |

[symbol]

indicates data missing or illegible when filed

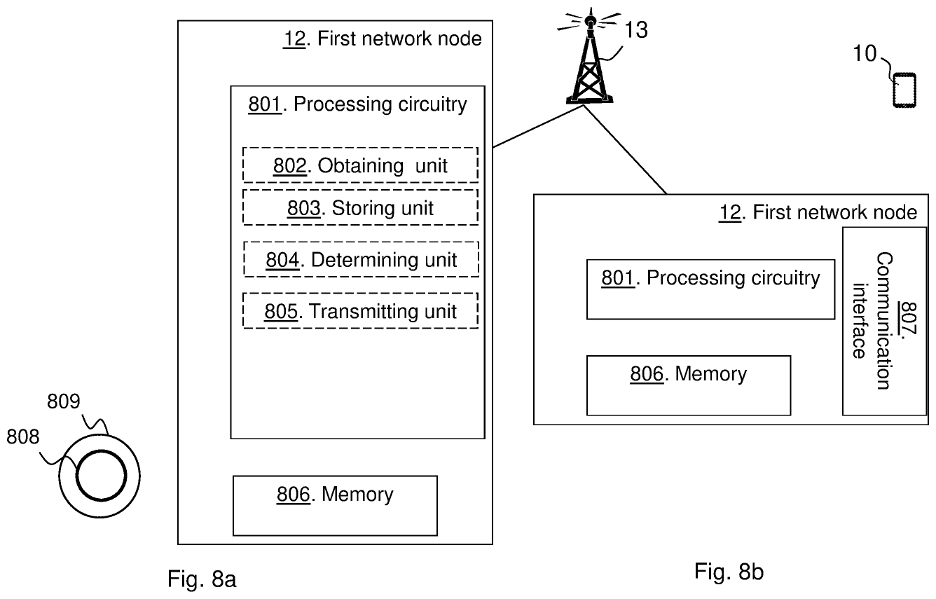

FIGS. 8a-8b are block diagrams depicting embodiments of the first network node 12, in two embodiments, for handling communication, e.g. handling, enabling or performing communication or HOs, in the wireless communications network 1 according to embodiments herein.

The first network node 12 may comprise processing circuitry 801, e.g. one or more processors, configured to perform the methods herein.

The first network node 12 may comprise an obtaining unit 802, e.g., a measuring unit, a receiver and/or a transceiver. The first network node 12, the processing circuitry 801 and/or the obtaining unit 802 may be configured to obtain the first indication and/or the second indication. For example, the first network node 12, the processing circuitry 801 and/or the obtaining unit 802 may be configured to obtain an RLF indication of the UE 10 in the first cell, and/or may obtain a SHR indication of the UE 10 to the first cell.

The first network node 12, the processing circuitry 801 and/or the obtaining unit 802 is configured to obtain the first report and/or the second report relating to radio performance and/or HO such as a RLF report or a SHR of the UE 10.

The first network node 12 may comprise a storing unit 803. The first network node 12, the processing circuitry 801 and/or the storing unit 803 may be configured to store UE related information, such as UE context, for the UE 10. The first network node 12, the processing circuitry 801 and/or the storing unit 803 may be configured to assign an identity to the UE 10, wherein the identity is different than an identity of another UE.

The first network node 12, the processing circuitry 801 and/or the storing unit 803 may be configured to store the indication that for the identity, i.e., the UE 10, included in the received first report, the first report and/or the second report has been received. The first network node 12, the processing circuitry 801 and/or the storing unit 803 may be configured to store a previous PCell indication included in the first report, or a source PCell indication included in the first report, or an HO identifier uniquely identifying the HO for the UE 10.

The first network node 12 may comprise a determining unit 804. The first network node 12, the processing circuitry 801 and/or the determining unit 804 may be configured to determine that the first and second report relates to the same UE based on C-RNTI in respective report.

The first network node 12 may comprise a transmitting unit 805, e.g., a transmitter and/or a transceiver. The first network node 12, the processing circuitry 801 and/or the transmitting unit 805 is configured to transmit, to the second network node 13, the one or more indication messages such as the first indication message, and/or the second indication message, wherein the indication message is associated with the first report and the second report. The one or more indication messages may comprise a HO identifier indication, uniquely identifying a HO for the UE 10. The indication message may be transmitted to the second network node 13 hosting the previous PCell in case of RLF-Report, or the source PCell of a HO, in case of SHR. The second indication message associated with the second report may be transmitted to the second network node 13 with the indication that the first report and the second report are for the same UE. Furthermore, the first network node 12, the processing circuitry 801 and/or the transmitting unit 805 may be configured to transmit the first report and the second report to the UE 10.

The first network node 12, the processing circuitry 801 and/or the storing unit 803 may be configured to delete the UE related information such as UE context once both the first and second report, i.e. RLF-Report and the SHR, are received for the UE 10, or when a timer has expired.

The first network node 12 further comprises a memory 806. The memory comprises one or more units to be used to store data on, such as indications, strengths or qualities, indication messages, reports, grants, messages, execution conditions, user data, configurations, scheduling information, timers, applications to perform the methods disclosed herein when being executed, and similar. The first network node 12 comprises a communication interface 807 comprising transmitter, receiver, transceiver and/or one or more antennas. Thus, it is herein disclosed a first network node for handling communication in the wireless communication network 1, wherein the first network node 12 comprises processing circuitry and a memory, said memory comprising instructions executable by said processing circuitry whereby said first network node 12 is operative to perform the method disclosed herein.

The methods according to the embodiments described herein for the first network node 12 are respectively implemented by means of e.g. a computer program product 808 or a computer program product, comprising instructions, i.e., software code portions, which, when executed on at least one processor, cause the at least one processor to carry out the actions described herein, as performed by the first network node 12. The computer program product 808 may be stored on a computer-readable storage medium 809, e.g. a universal serial bus (USB) stick, a disc or similar. The computer-readable storage medium 809, having stored thereon the computer program product, may comprise the instructions which, when executed on at least one processor, cause the at least one processor to carry out the actions described herein, as performed by the first network node 12. In some embodiments, the computer-readable storage medium may be a non-transitory or transitory computer-readable storage medium.

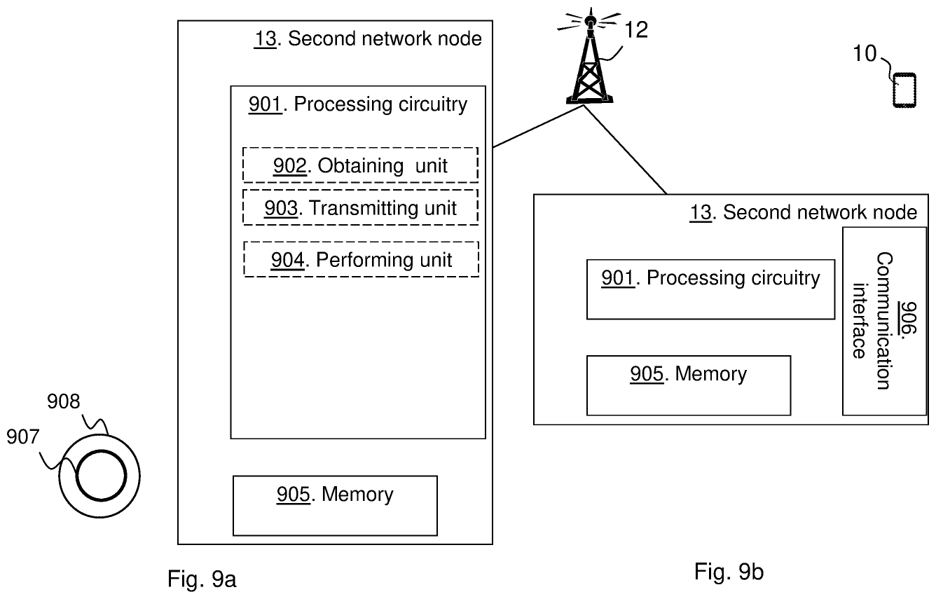

FIGS. 9a-9b are block diagrams depicting embodiments of the second network node 13 for handling communication, e.g. handling, enabling or performing communication or HO to the second network node, in the wireless communication network 1 according to embodiments herein.

The second network node 13 may comprise processing circuitry 901, e.g. one or more processors, configured to perform the methods herein.

The second network node 13 may comprise an obtaining unit 902, e.g. a receiver or a transceiver. The second network node 13, the processing circuitry 901 and/or the obtaining unit 902 may be configured to obtain the first report and/or the second report relating to radio performance and/or HO such as a RLF report or a SHR of the UE 10. These reports may be obtained from the first network node 12 or another network node.

The second network node 13, the processing circuitry 901 and/or the obtaining unit 902 is configured to receive, from the first network node 12, the one or more indication messages such as the first indication message, and/or the second indication message, wherein the indication message is associated with the first report and the second report relating to radio performance and/or HO of the UE 10. The one or more indication messages may comprise a HO identifier indication, uniquely identifying a HO for the UE 10. The second network node 13 may be hosting the previous PCell in case of RLF-Report, or the source PCell of a HO, in case of SHR. The second indication message associated with the second report may comprise the indication that the first report and the second report are for the same UE and/or HO.

The second network node 13 may comprise a transmitting unit 903, e.g. a transmitter or a transceiver. The second network node 13, the processing circuitry 901 and/or the transmitting unit 903 may be configured to send the request to the first network node 12, requesting whether the second report may be received associated with the same UE 10, or whether the first report has already been sent.

The second network node 13 may comprise a performing unit 904. The second network node 13, the processing circuitry 901 and/or the performing unit 904 may be configured to perform the action related to HO of the UE 10. The second network node 13, the processing circuitry 901 and/or the performing unit 904 may be configured to initiate or perform the correlation to correlate the first and the second report based on the one or more indication messages such as the first and/or second indication message. The second network node 13, the processing circuitry 901 and/or the performing unit 904 may be configured to take, or make a third network node take, into account the first report associated with the received first indication message for network parameters optimization, or discard the first report.

The second network node 13 further comprises a memory 905. The memory comprises one or more units to be used to store data on, such as indication messages, reports, strengths or qualities, grants, indications, configuration, values, scheduling information, timers, applications to perform the methods disclosed herein when being executed, and similar. The second network node 13 comprises a communication interface 906 comprising transmitter, receiver, transceiver and/or one or more antennas.

Thus, it is herein disclosed a second network node 13 for handling communication in the wireless communication network 1, wherein the second network node 13 comprises processing circuitry and a memory, said memory comprising instructions executable by said processing circuitry whereby said second network node 13 is operative to perform the method disclosed herein.

The methods according to the embodiments described herein for the second network node 13 are respectively implemented by means of e.g. a computer program product 907 or a computer program product, comprising instructions, i.e., software code portions, which, when executed on at least one processor, cause the at least one processor to carry out the actions described herein, as performed by the second network node 13. The computer program product 907 may be stored on a computer-readable storage medium 908, e.g. a universal serial bus (USB) stick, a disc or similar. The computer-readable storage medium 908, having stored thereon the computer program product, may comprise the instructions which, when executed on at least one processor, cause the at least one processor to carry out the actions described herein, as performed by the second network node. In some embodiments, the computer-readable storage medium may be a non-transitory or transitory computer-readable storage medium.

### Embodiment 1

A method performed by a first network node for handling communication in a wireless communications network, the method comprising
obtaining a first report and/or a second report relating to radio performance and/or HO such as a RLF report or a SHR of the UE 10; and
transmitting to a second network node, one or more indication messages, such as a first indication message, and/or a second indication message, wherein an indication message is associated with the first report and the second report.

### Embodiment 2

The method according to embodiment 1, further comprising
assigning an identity to the UE, wherein the identity is different than an identity of another UE.

### Embodiment 3

The method according to any of the embodiments 1-2, further comprising
determining that the first and second report relate to the same UE.

### Embodiment 4

The method according to any of the embodiments 1-3, wherein the indication message is transmitted to the second network node hosting a previous PCell in case of RLF-Report, or a source PCell of a HO, in case of SHR.

### Embodiment 5

A method performed by a second network node for handling communication in a communication network, the method comprising
receives from a first network node, one or more indication messages, such as a first indication message, and/or a second indication message, wherein an indication message is associated with a first report and a second report relating to radio performance and/or HO such as a RLF report or a SHR of the UE 10.

### Embodiment 6

The method according to embodiment 5, further comprising
performing an action related to the HO of the UE.

### Embodiment 7

The method according to embodiment 6, wherein performing comprises initiating or performing a correlation to correlate the first and the second report based on the first and/or second indication message.

### Embodiment 8

The method according to any of the embodiments 5-7, further comprising
sending a request to the first network node, requesting whether a second report may be received associated with the same UE, or whether a first report has already been sent.

### Embodiment 9

A first network node for handling communication in a wireless communications network, wherein the first network node is configured to
obtain a first report and/or a second report relating to radio performance and/or HO such as a RLF report or a SHR of the UE; and
transmit to a second network node, one or more indication messages, such as a first indication message, and/or a second indication message, wherein an indication message is associated with the first report and the second report.

### Embodiment 10

The first network node according to embodiment 9, wherein the first network node is configured to
assign an identity to the UE, wherein the identity is different than an identity of another UE.

### Embodiment 11

The first network node according to any of the embodiments 9-10, wherein the first network node is configured to
determine that the first and second report relate to the same UE.

### Embodiment 12

The first network node according to any of the embodiments 9-11, wherein the indication message is transmitted to the second network node hosting a previous PCell in case of RLF-Report, or a source PCell of a HO, in case of SHR.

### Embodiment 13

A second network node for handling communication in a communication network, wherein the second network node is configured to
receive from a first network node, one or more indication messages, such as a first indication message, and/or a second indication message, wherein an indication message is associated with a first report and a second report relating to radio performance and/or HO such as a RLF report or a SHR of the UE.

### Embodiment 14

The second network node according to embodiment 13, wherein the second network node is configured to perform an action related to the HO of the UE.

### Embodiment 15

The second network node according to embodiment 14, wherein the second network node is configured to perform the action by initiating or performing a correlation to correlate the first and the second report based on the first and/or second indication message.

### Embodiment 16

The second network node according to any of the embodiments 13-15, wherein the second network node is configured to send a request to the first network node, requesting whether a second report may be received associated with the same UE, or whether a first report has already been sent.

In some embodiments a more general term “network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or UE is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices. Embodiments herein may configure the block error rate (BLER) target for a communication session between a network node and a UE.

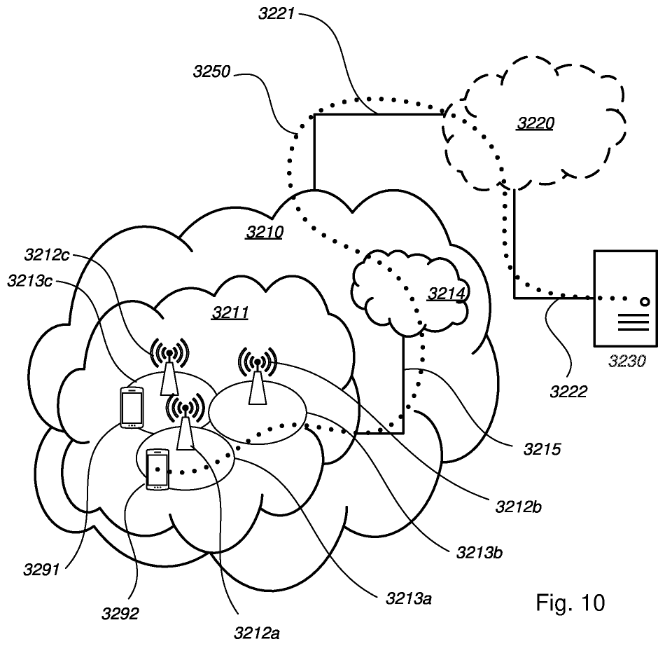

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the network nodes 12,13 herein, each defining a corresponding coverage area 3213a, 3213b, 3213c. Each base station 3212a, 3212b, 3212c is connectable to the core network 3214 over a wired or wireless connection 3215. A first UE 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

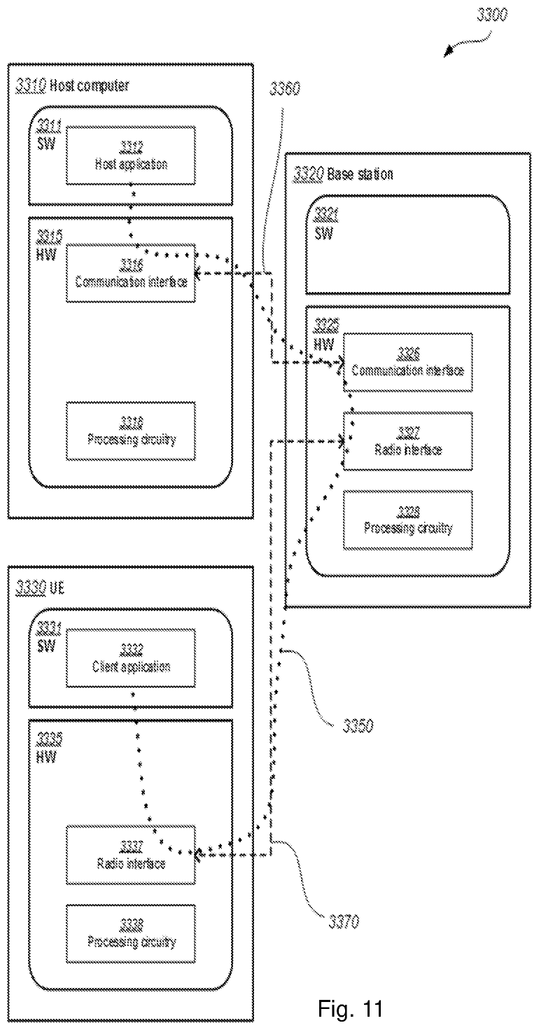

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may achieve a more reliable optimization and thereby provide benefits such as improved battery time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

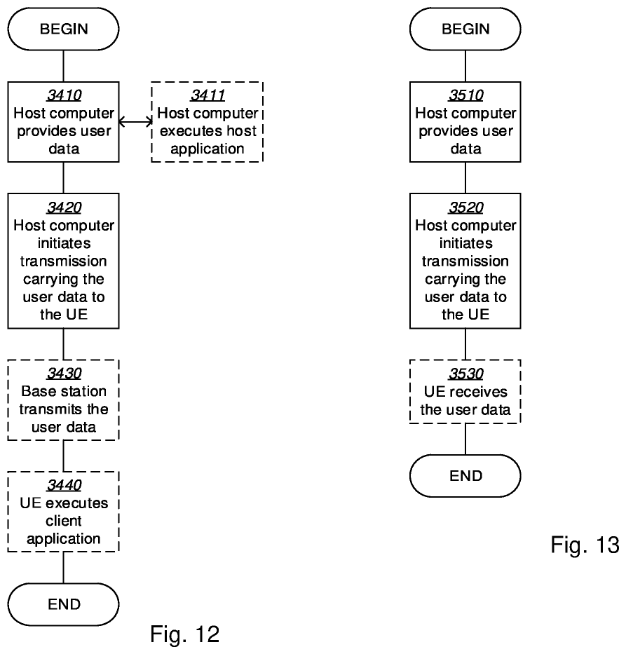

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

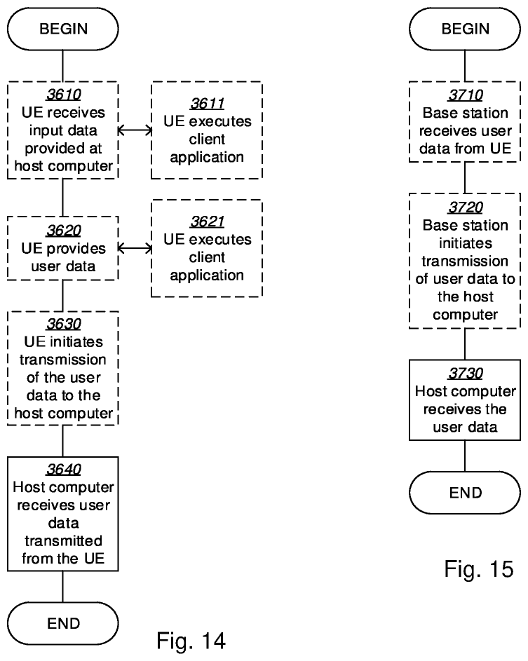

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-22. (canceled)

23. A method performed by a first network node for handling communication in a wireless communications network, the method comprising:
obtaining a first report and/or a second reports relating to radio performance and/or handover (HO) of a user equipment (UE); and
transmitting to a second network node, one or more indication messages, wherein an indication message is associated with the first report and the second report.

24. The method of claim 23, further comprising:
assigning an identity to the UE, wherein the identity is different than an identity of another UE.

25. The method of claim 23, wherein the one or more indication messages comprise a HO identifier indication uniquely identifying a HO for the UE.

26. The method of claim 23, further comprising:
determining that the first and second report relate to the same UE based on a cell-radio network temporary identifier (C-RNTI) in respective report.

27. The method of claim 23, wherein the indication message is transmitted to the second network node hosting a previous primary cell (PCell) in case of radio link failure (RLF) Report, or a source PCell of a HO, in case of successful HO report (SHR).

28. A method performed by a second network node for handling communication in a communication network, the method comprising
receiving from a first network node, one or more indication messages, wherein an indication message is associated with a first report and a second report relating to radio performance and/or handover (HO) of a user equipment (UE).

29. The method of claim 28, wherein the one or more indication messages comprises a HO identifier indication uniquely identifying a HO for the UE.

30. The method of claim 28, further comprising:
performing an action related to the HO of the UE.

31. The method of claim 30, wherein performing the action comprises initiating or performing a correlation to correlate the first and the second report based on the one or more indication messages.

32. The method of claim 28, further comprising:
sending a request to the first network node, requesting whether a second report may be received associated with the same UE, or whether a first report has already been sent.

33. A first network node for handling communication in a wireless communications network, the first network node comprising communication interface circuitry and processing circuitry operatively coupled to the communication circuitry, wherein the processing circuitry is configured to:
obtain a first report and/or a second report relating to radio performance and/or handover (HO) of a user equipment (UE); and
transmit to a second network node, one or more indication messages, wherein an indication message is associated with the first report and the second report.

34. The first network node of claim 33, wherein the processing circuitry is configured to:
assign an identity to the UE, wherein the identity is different than an identity of another UE.

35. The first network node of claim 33, wherein the one or more indication messages comprises a HO identifier indication, uniquely identifying a HO for the UE.

36. The first network node of claim 33, wherein the processing circuitry is configured to:
determine that the first and second report relate to the same UE based on cell-radio network temporary identifier (C-RNTI) in respective report.

37. The first network node of claim 33, wherein the indication message is transmitted to the second network node hosting a previous primary cell (PCell) in case of radio link failure (RLF) Report, or a source PCell of a HO in case of successful HO report (SHR).

38. A second network node for handling communication in a communication network, the second network node comprising communication interface circuitry and processing circuitry operatively coupled to the communication circuitry, wherein the processing circuitry is configured to:
receive from a first network node, one or more indication messages, wherein an indication message is associated with a first report and a second report relating to radio performance and/or handover (HO) of a user equipment (UE).

39. The second network node of claim 38, wherein the one or more indication messages comprise a HO identifier indication, uniquely identifying a HO for the UE.

40. The second network node of claim 38, wherein the processing circuitry is configured to:
perform an action related to the HO of the UE.

41. The second network node of claim 40, wherein the processing circuitry is configured to perform the action comprises initiating or performing a correlation to correlate the first and the second report based on the one or more indication messages.

42. The second network node of claim 38 wherein the processing circuitry is configured to send a request to the first network node, requesting whether a second report may be received associated with the same UE, or whether a first report has already been sent.
